(19) United States
(12) Patent Application Publication
(10) Pub. No.: US 2025/0328910 A1
(43) Pub. Date: Oct. 23, 2025

(54) LIQUIDITY ASSESSMENT

(71) Applicant: Wells Fargo Bank, N.A., San Francisco, CA (US)

(72) Inventors: Ravi Indrajith Katkar, Hyderabad (IN); Chandrabhan Kushwaha, Bangalore (IN); Govinda Rajulu Nelluri, Hyderabad (IN); Vijaya Kumar Rasala, Hyderabad (IN)

(21) Appl. No.: 18/639,264

(22) Filed: Apr. 18, 2024

(51) Int. Cl. G06Q 20/40

(52) U.S. Cl. CPC G06Q 20/403; G06Q 2220/00

(57) ABSTRACT

Managing payment requests. When a liquidity manager goes down, last-known liquidity data can be obtained from a stand-in liquidity manager to execute requested payments even while the liquidity manager is down. Based on a context of a requested payment, execution of the payment can be either performed in real-time using the stand-in liquidity manager or queued until a later time when the liquidity manager is back up.

### BACKGROUND

Online transactions play a significant role in simplifying the banking experience of bank customers. Online transactions enable customers of financial institutions, or payors, to quickly transfer funds to desired payees. When a payor initiates a transaction, a payment processing system interfaces with a liquidity management system to determine whether sufficient liquidity is available in the payor's transaction account to complete the transaction.

### SUMMARY

In general terms, the present disclosure relates to handling payment requests when a liquidity management system is unavailable. In some examples, handling the payment requests can include executing the requested payments even while the liquidity management system is unavailable.

In one aspect, the present disclosure relates to a computing system for processing payment requests, including: a processor; and memory encoding instructions which, when executed by the processor, cause the computing system to: receive, from a user device, a payment request for online payment from a transaction account; receive, from a payment processing system, a message indicating that liquidity data associated with the transaction account and for processing the payment request is unavailable from a liquidity management repository; in response to the message: access a stand-in liquidity management repository; and determine, based on stand-in liquidity data stored in the stand-in liquidity management repository, a previous liquidity balance for the transaction account at a time before the liquidity data became unavailable from the liquidity management repository; and execute, by the payment processing system, a payment corresponding to the payment request based on the previous liquidity balance.

In a further aspect, the present disclosure relates to a computer-implemented method for processing payment requests, including: receiving, from a user device, a payment request for online payment from a transaction account; receiving, from a payment processing system, a message indicating that liquidity data associated with the transaction account and for processing the payment request is unavailable from a liquidity management repository; in response to the message: determining a context of the payment request; when the context is determined to be a first context, accessing a stand-in liquidity management repository to enable the payment processing system to execute a payment corresponding to the payment request while the liquidity data is unavailable from the liquidity management repository; and when the context is determined to be a second context different from the first context, queueing execution of the payment corresponding to the payment request until after the liquidity data becomes available from the liquidity management repository.

In yet a further aspect, the present disclosure relates to a computing system for processing payment requests, including: a processor; and memory encoding instructions which, when executed by the processor, cause the computing system to: receive, from a user device, a payment request for online payment from a transaction account; receive, from a payment processing system, a message indicating that liquidity data associated with the transaction account and for processing the payment request is unavailable from a liquidity management repository; in response to the message: determine whether the payment request is for a real-time payment from the transaction account or for a scheduled future payment from the transaction account; when the payment is for a real-time payment from the transaction account: access a stand-in liquidity management repository; determine, based on stand-in liquidity data stored in the stand-in liquidity management repository, a previous liquidity balance for the transaction account at a time before the liquidity data became unavailable from the liquidity management repository; and execute, by the payment processing system, a payment corresponding to the payment request based on the previous liquidity balance; and when the payment is for a scheduled future payment from the transaction account: queue execution of the payment corresponding to the payment request until after the liquidity data becomes available from the liquidity management repository; and execute, by the payment processing system, the payment corresponding to the payment request after the liquidity data becomes available from the liquidity management repository.

Each of these aspects, and other aspects, of the present disclosure, can be implemented in a variety of ways including, for example, in the form of one or more of a computing system, a computing device, a method (e.g., a computer-implemented method), non-transitory computer-readable storage, a plurality of computing devices, and the like.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example payment managing system.

FIG. 2 shows additional details associated with the example components of the payment managing system of FIG. 1.

FIG. 3 shows an example method that can be performed by the payment managing system of FIG. 1.

FIG. 4 shows additional details of the stand-in liquidity management repository of FIG. 2.

FIG. 5 shows example physical components of portions of the system of FIG. 1.

### DETAILED DESCRIPTION

Customers of financial institutions hold transaction accounts, such as checking accounts, savings accounts, and credit card accounts, which are managed by the financial institutions. Online transaction services provided by the financial institutions can enable customers to make payments from their transaction accounts to payee transaction accounts of their choice. A customer (or payor) and the payee can be any of: an individual, a business, a merchant, a financial institution, and the like.

In a typical online payment transaction, a financial institution server receives an online request from a payor device to make a payment from a customer's transaction account to a payee account. The server than accesses a liquidity management system, which stores an up-to-date transaction ledger for the payor transaction account. Based on the data in the transaction ledger relating to the status of the payor account, the server determines whether there is sufficient liquidity to complete the requested payment.

For example, if the payment request is 50 dollars, the last known balance is 100 dollars, and the only pending transaction is for the transaction account to receive a payment of 20 dollars, then the server determines there is sufficient liquidity to complete the requested payment. If, on the other hand, the payment request is for 50 dollars, the last known balance is 100 dollars, and the only pending transaction is for a payment out of the account of 60 dollars, then the server determines that there is not sufficient liquidity to complete the requested payment and the requested payment is denied.

Payments that have been requested can be queued, and thereby delayed, due to downtime in a financial institution's liquidity management repository. As the terms are used herein, a liquidity management repository (also referred to as a liquidity management system) is “down” or experiencing “downtime” if an account transaction ledger stored by the liquidity management system or repository is unavailable for performing a requested payment from a transaction account associated with the transaction ledger.

As the terms are used herein, a payment or payment request includes any kind of money transfer or requested money transfer, respectively, from one account to another account. A payment can be a payment for a sum due, for example, or simply a transfer of funds from one account of a customer to another account of the customer. Thus, in some examples, the payee is an entity different than the payor making the payment request, and in other examples the payee is the same entity as the payor.

The downtime can be scheduled (e.g., periodic) downtime, or unexpected downtime. An example unexpected or unscheduled downtime is downtime due to failure of a hardware component or a software component that runs the liquidity management system. In another example, unexpected downtime is caused by a cyberattack that impacts the liquidity management system's functionality.

As one example of an expected or scheduled downtime for a liquidity management system, the transaction ledger of the liquidity management system becomes unavailable (e.g., for a period of time each day, each week, each month, etc.) to perform requested transactions while interest calculations for financial accounts whose liquidity data is stored by the liquidity management system are being calculated. As another example of an expected or scheduled downtime for a liquidity management system, the transaction ledger of the liquidity management system becomes unavailable (e.g., for a period of time each day) while it performs other end-of-day jobs, such as installing software updates. In yet another example, the downtime can be unexpected or unscheduled, such as when the liquidity management system might become inaccessible due to an outage in the network or other computing error.

Typically, when there is downtime in the liquidity management system, a payment request can be placed in a queue and may not be processed until the liquidity management system or repository comes back online (i.e., is no longer experiencing downtime). Such delays increase processing time for the impacted transactions, which can be problematic, particularly for real-time payment requests, which require immediate execution (also referred to herein as “completion”).

Aspects of the present disclosure advantageously provide for automated detection of liquidity management system downtime.

Aspects of the present disclosure advantageously provide for automated detection of a liquidity management system becoming available again for performing transactions after being down.

Further aspects of the present disclosure advantageously provide for automated activation and deactivation of a stand-in liquidity management system based on a detected operational status of the liquidity management system.

Further aspects of the present disclosure advantageously provide for automated execution of a requested payment even while the liquidity management system is down.

Further aspects of the present disclosure advantageously provide for automated updating of a transaction ledger of the liquidity management system, based on the transaction executed while the liquidity management system was down, after the liquidity management system comes back up.

Further aspects of the present disclosure advantageously provide for automated execution, queueing or denial of a requested payment while the liquidity management system is down based on an automatically determined context of the requested payment.

Further aspects of the present disclosure advantageously provide for interfacing between a server on the one hand, and a liquidity management system and a stand-in liquidity management system on the other hand, where transaction ledgers are stored in the liquidity management system and the stand-in liquidity managements system according to different database schema.

Further aspects of the present disclosure advantageously provide for interfacing between a server on the one hand, and a liquidity management system and a stand-in liquidity management system on the other hand, where transactions are stored across a distributed ledger in the stand-in liquidity management system and at least some of the same transactions are stored in a non-distributed ledger in the liquidity management system.

Each of these aspects, and combinations of these aspects, is performed by transmission, receipt, and processing of particular signals by different computing devices. For example, a server computing device receives first signals from a payor computing device providing a payment request including context data related to the payment request. The server receives second signals form a payment processing system that provide the server with status data relating to a liquidity management repository of the payment processing system. Based on the first signals and the second signals, the server generates third second signals or fourth signals that are sent to the payment processing system to access either a liquidity management repository or a stand-in liquidity management repository. The payment processing system 16 then generates fifth signals or sixth signals, depending on which repository is accessed, that are sent to the server to provide the server with liquidity data or standing liquidity data. Based on the fifth or sixth signals, the server then executes, denies or queues the requested payment. If payment is executed, the server can generate seventh signals that are sent to the payment processing system to update one or more ledgers stored by the payment processing system.

These and other examples herein are technological improvements specifically within the technological field of online payment services. The improvements relate to, among other things, computing systems that can automatically execute payments even when certain computing components typically required to complete the payments are down.

### System Overview

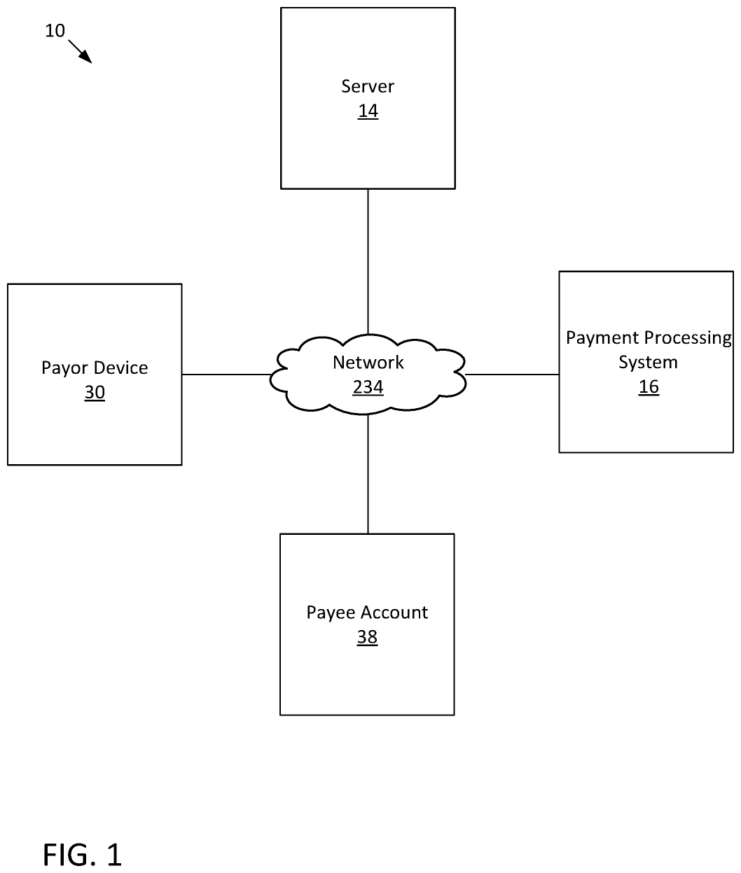

FIG. 1 shows an example payment managing system 10.

The system 10 includes a server 14, a payment processing system 16, a payor device 30, and a payee account 38 that are networked together via a network 234.

The server 14 can be managed by a financial institution. The server 14 can represent a single server, e.g., that is operated exclusively by a financial institution. Alternatively, the server 14 can include multiple computing devices, with the functionality of the server 14 being distributed across the multiple computing devices using the network 234. For instance, the server 14 can represent a computing cloud that a financial institution accesses to perform functions of the server 14 described herein.

The server 14, the payment processing system 16, and the payor device 30 each can include a processor and non-transitory computer readable storage storing instructions executable by the respective processor to perform functions described herein.

In some examples, the payment processing system 16 includes hardware that is standalone from the server 14. In other examples, the payment processing system is a component of the server 14 and the functionality of the payment processing system 16 is performed by the server 14.

The payee account 38 is supported by one or more computing devices, which can include hardware that is standalone from the server 14. In other examples, the functionality is performed by the server 14.

The network 234 can be any suitable network or combination of networks for operably coupling computing devices to one another so that the computing devices can communicate computing signals between one another.

The payor device 30 can be, for example, a smartphone, a tablet, a smartwatch or other smart wearable technology, a virtual reality device, an augmented reality device, a desktop computer, and the like.

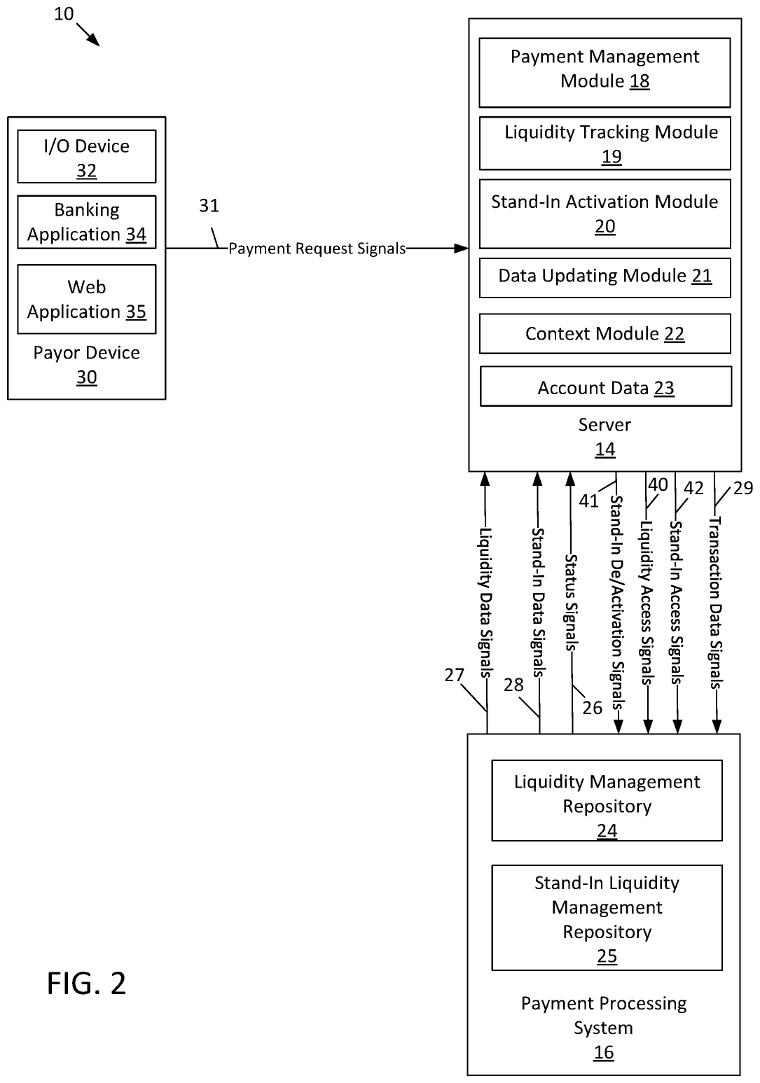

FIG. 2 shows example components of the payment managing system of FIG. 1, including components of the payor device 30, the server 14, and the payment processing system 16.

The payor device 30 includes in input/output (I/O) device 32, as well as a banking application 34 and a web application 35 both locally stored on non-transitory computer-readable storage of the payor device 30.

The I/O device 32 can include, for example, one or more of a display, a touch screen, a microphone, a speaker, a keypad, a mouse, a stylus, and the like. For example, a display or touchscreen of the I/O device 32 can display user interfaces generated by the banking application 34 and the web application 35 and receive payor input, such as input that generates a payment request.

The banking application 34 can be a software application that provides banking functionality, such as access to transaction accounts and ability to initiate and perform various activities related to such transaction accounts, such as viewing balances, making payments, performing money transfers, and the like. A payor for example, opens the banking application 34, and enters credentials via the I/O device 32 linked to the payor's transaction account managed on the server 14. Once access to the transaction account is granted, the payor can, for example, use the banking application 34 to request a payment from the linked transaction account to a payee account, e.g., a service vendor, a friend, a family member, and the like.

The web application 35 can be a software application that provides access to the Internet or to a service or platform that is hosted on the Internet. For example, the web application 35 can be an Internet browser. The web application 35 can be used to navigate, via the I/O device 32, to a webpage hosted by the financial institution that manages the server 14. A payor can then enter credentials linked to the payor's transaction account managed on the server 14. Once access to the transaction account is granted via the web page, the payor can, for example, use the webpage generated by the web application 35 to request a payment from the linked transaction account to a payee account, e.g., a service vendor, a friend, a family member, and the like.

The server 14 stores, or has access via the network 234 (FIG. 1), to one or more external databases that store, account data 23. The account data 23 can include customer information associated with different transaction accounts of customers, such as an account number, a type of account (e.g., checking, savings, credit), the name of the account owner, whether the account is a business account or a personal account, customer contact information, customer age, customer work profile, information about customer communication data with a financial institution, and the like. The account data 23 can also include details of loans availed by the customer, average balance, available balance, and other information associated with one or one or more transaction accounts of the customer.

The account data 23 can include rules that determine how the account owner (or customer) can use the account. Which rules apply to a given account can be based on the customer's relationship with the financial institution (e.g., a customer loyalty level or status level, a minimum account balance, whether the customer is an individual or a business, a credit worthiness of the customer, and the like). For example, such rules can limit real-time payments or transfers to a maximum dollar amount (e.g., five thousand dollars) or maximum number of such payments per time period (e.g., three payments per 24 hours), with any requested transfer above the maximum amount or above the maximum number requiring to be executed as a future scheduled payment and not as a real-time payment. The maximum dollar amount or maximum number (or threshold for another such factor) can depend on the customer's relationship with the financial institution and/or other factors described herein. The account data 23 can also include sufficient information about approved payee or transferee accounts to make payments to the payee account 38 from the payor's account.

The server 14 also includes, stored on non-transitory computer-readable storage, a payment management module 18, a liquidity tracking module 19, a stand-in activation module 20, a data updating module 21, and a context module 22. These modules encode instructions that, when executed by one or more processors, cause the server 14 to process signals received by the server 14 in particular ways, and further cause the server 14 to generate other signals, as will be further described herein, to provide functionality of the server 14 and of the system 10 (FIG. 1).

The payment processing system 16 includes a liquidity management repository 24 and a stand-in liquidity management repository 25.

The liquidity management repository 24 can be a component of a liquidity management system that, in some examples, can include one or more of its own dedicated processors. When the liquidity management system goes down, the liquidity management repository 24 becomes unavailable for performing requested payments. That is, the liquidity data stored by the liquidity management repository 24 becomes unavailable for performing payment requests when the liquidity management system or the liquidity management repository goes down.

The liquidity management repository 24 stores liquidity data for transaction accounts corresponding to the account data 23. The liquidity data can be in the form of a transaction ledger that provides transaction information (e.g., monetary amounts and time of occurrence) for each payment into and out of a transaction account, a current balance in the transaction account, and any pending transactions for payments into and out of the transaction account that are not yet reflected in the current (or available) balance.

When the liquidity management repository 24 goes down, the stand-in liquidity management repository 25 stores last available liquidity data for the transaction accounts corresponding to the account data 23. The stand-in liquidity data can be in the form of a distributed ledger or blockchain that provides last available transaction information (e.g., monetary amounts and time of occurrence) about payments into and out of a transaction account, a last available balance in the transaction account, and any last available data relating to pending transactions for payments into and out of the transaction account that are not yet reflected in the current balance, with all such last available (also referred to herein as last seen or last known) liquidity data being provided to the stand-in liquidity management repository 25 based on liquidity data stored in the liquidity management repository 24 at some point before the liquidity management repository went down.

For example, liquidity data from the liquidity management repository 24 can be periodically (e.g., every minute, every five minutes, every 60 minutes, every 12 hours, every 24 hours) downloaded, e.g., using the server 14, onto the stand-in liquidity management repository 25, with the most recent download corresponding to the last available liquidity data when the liquidity management repository 24 goes down. As another example, the server 14 is configured to automatically download liquidity data from the liquidity management repository 24 onto the stand-in liquidity management repository 25 some amount of time or predefined amount of time (e.g., one minute, five minutes, 60 minutes) before a scheduled downtime of the liquidity management repository 24. As another example, the stand-in liquidity management repository 25 can import (e.g., using the server 14), from the account data 23, an available balance of a given transaction account from which a payment has been requested during downtime of the liquidity management repository 24, with such imported data serving as the stand-in liquidity data or a component of the stand-in liquidity data.

The liquidity data and the stand-in liquidity data can be stored, by their respective repositories, according to different database schema and/or other different storage techniques. For example, the liquidity data can be stored in a non-distributed ledger on a single database, whereas the stand-in liquidity data can be stored in a blockchain and/or as a distributed ledger across multiple databases.

Such different storage techniques or schema may require different protocols for accessing, by the server 14, of the liquidity management repository 24 versus accessing of the stand-in liquidity management repository 25.

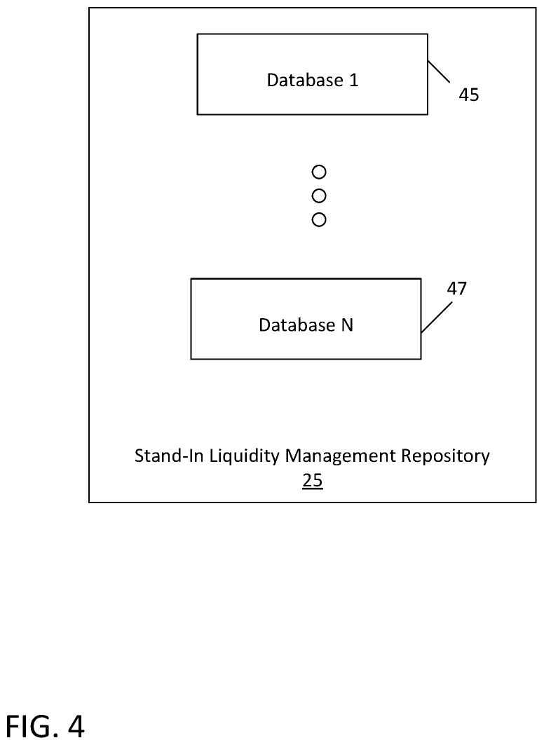

FIG. 4 shows additional details of the stand-in liquidity management repository 25 of FIG. 2 in an example in which the stand-in liquidity management repository 25 includes multiple databases as just described. The multiple databases include a first database 45 up to and including an Nth database 47, where N is a positive integer greater than 1.

Referring again to FIG. 2, in some examples, one or more software plugins are provided that are installed in the server 14. The plugins can enable one or more modules of the server 14, via different application programming interfaces (APIs) between the modules and the payment processing system 16, to interface with each of the liquidity management repository 24 and the stand-in liquidity management repository 25 using different interface protocols. For example, one of the interface protocols compatible with one or more by the APIs can enable the liquidity tracking module 19 to interface with a distributed ledger or block chain in order to interface with the stand-in liquidity management repository 25, while another of the interface protocols used to access the liquidity management repository 24 does not enable interfacing of the payment management module 18 with a distributed ledger or blockchain but does enable interfacing of the payment management module 18 with a non-distributed transaction ledger stored in the liquidity management repository 24.

Since the stand-in liquidity management repository 25 can present another source for potentially unauthorized compromising or accessing of customer data, storing the stand-in liquidity data in a distributed ledger or blockchain can advantageously enhance the security of the stand-in liquidity data, and help to prevent such unauthorized access or usage of sensitive customer data.

### Example Implementations

An example implementation of the components of the system of FIG. 2 will now be described.

Via the I/O device 32 and using the banking application 34 or the web application 35, a payor enters valid credentials that are accepted by the server 14 based on the account data 23. Thereby, the customer accesses a transaction account corresponding to the account data 23. While accessing the transaction account, the customer than enters a payment request via the I/O device 32 to make a payment from the transaction account to the payee account 38 (FIG. 1). Via the I/O device 32 the payment request is selected to be either a real-time payment request or a scheduled payment request.

The payment request causes the payor device 30 to generate payment request signals 31 that are transmitted via the network 234 (FIG. 1) and received by the server 14. The payment request signals can include data packets with payloads and headers carrying various data and metadata that provide information about the payment request. For example, the signals 31 can provide the server 14 with an identification of the payor account, an identification of payee account, a requested amount of the payment, the type of payment request (e.g., real-time or scheduled), and a timestamp indicating when the payment request occurred.

The payment management module 18 is configured to cause the server 14 to process the signals 31 to determine whether to complete the payment request. The payment management module 18 cooperates with the stand-in activation module 20 and the context module 22 to cause the server 14 to process the signals 31.

For example, in response to receiving the signals 31, the payment management module 18 causes the server 14 to generate liquidity access signals 40 which are transmitted, via the network 234, and received by the payment processing system 16. The liquidity access signals 40 query the liquidity management repository 24 and thereby determine if liquidity data stored on the liquidity management repository is available or if the liquidity management repository 24 is down. More particularly, in response to receiving the liquidity access signals 40, the payment processing system 16 is configured to generate status signals 26, which are transmitted over the network 234 and received by the server 14. The status signals 26 provide data indicating whether the liquidity management repository is down or not down. The status signals 26 are processed using the payment management module 18 to determine whether liquidity data is available from the liquidity management repository 24.

If the liquidity data is available, the payment processing system 16 generates liquidity data signals 27 that are transmitted via the network 234 and received by the server 14. The liquidity data signals 27 provide current liquidity data for the payor transaction account for which the payment request has been received. The payment management module 18 is configured to process the signals 27 to determine if there is sufficient liquidity to execute the requested payment and, based on that determination, either completes or denies the requested payment from the payor account to the payee account 38 (FIG. 1).

If the liquidity data is not available, meaning that the liquidity management repository is down, the payment management module 18 determines whether to hand off the payment request to the stand-in activation module 20 or rather to queue the payment request until after the liquidity management repository becomes available again.

To make this determination, the context module 22 is configured to cause the server 14 to process the payment request signals 31 to determine a context of the payment request. The context module 22 is further configured to cause the server 14 to cross-reference the determined context against transaction rules associated with the payor account and/or the payee account as stored in the account data 23.

The context of the payment is provided in the data packets carried by the payment request signals. The context can include, for example, the type of the requested payment (e.g., real-time or scheduled), the monetary amount of the requested payment, and the time the request was made.

If the context module 22 determines that the context of the payment request indicates that the payment request is for future scheduled payment and not for real-time payment, the payment management module 18 queues the payment request and does not pass the payment request management workflow to the stand-in activation module 20.

If the context module 22 determines that the context of the payment request indicates that the payment request is for real-time payment, the context module cross-references the other context data against the rules stored in the account data to determine if the real-time payment request is permitted. For example, if, for the given customer, the amount of the payment request is not a permitted amount for a real-time payment or the time of the payment request indicates that the number of permitted real-time payment requests for a given time period that includes the time of the payment request has been or is being exceeded, then the context module 22 determines that the real-time payment request is not permitted, and the payment management module 18 queues the payment request and does not hand off the workflow to the stand-in activation module 20. A message can also be sent to the payor device indicating that the real-time request has been converted to a scheduled request due to its context, and has been queued.

If, on the other hand, for the given customer, the amount of the payment request is a permitted amount for a real-time payment and the time of the payment request indicates that the number of permitted real-time payment requests for a given time period that includes the time of the payment request has not been and is not being exceeded, then the context module 22 determines that the real-time payment request is permitted, and the payment module 18 hands off the workflow to the stand-in activation module 20.

The stand-in activation module 20 is configured to cause the server 14 to generate signals 41, which are configured to cause the payment processing system to activate and deactivate the stand-in liquidity management repository 25. When the stand-in liquidity management repository 25 is activated, the liquidity tracking module 19 is able to access the stand-in liquidity data stored by the stand-in liquidity management repository 25. When the stand-in liquidity management repository 25 is deactivated, the liquidity tracking module 19 is unable to access the stand-in liquidity data stored by the stand-in liquidity management repository 25.

The stand-in activation module 20 is configured to activate the stand-in liquidity management repository 25 only when the liquidity management repository 24 is down. In some examples, the stand-in activation module 20 is configured to activate the stand-in liquidity management repository 25 only when the liquidity management repository 24 is down and there is an otherwise permitted real-time payment request to complete. Minimizing or otherwise limiting activation time of the stand-in liquidity management repository 25 in this manner can minimize undue use or undue reliance on the stand-in liquidity data for making transactions, which may be advantageous since the stand-in liquidity data may not always accurately reflect actual up-to-date liquidity for a given transaction account.

Once the signals 41 cause the payment processing system 16 to activate the stand-in liquidity management repository 25, the workflow passes to the liquidity tracking module 19. The liquidity tracking module 19 is configured to cause the server 14 to generate stand-in liquidity access signals 42, which are transmitted, via the network 234 and received by the payment processing system 16. The stand-in liquidity access signals cause the payment processing system 16 to generate stand-in data signals 28 that are transmitted via the network 234 and received by the server 14. The signals 28 provide stand-in liquidity data stored in the stand-in liquidity management repository 25 to the liquidity tracking module 19.

The liquidity tracking module 19 is configured to calculate, based on the stand-in liquidity data obtained from the stand-in liquidity management repository 25, a stand-in liquidity of the transaction account from which a real-time payment has been requested and otherwise approved.

The payment management module 18 is configured, based on the stand-in liquidity calculated by the liquidity tracking module 19, to determine if there is sufficient liquidity to execute the requested payment and, based on that determination, either completes or denies the requested payment from the payor account to the payee account 38 (FIG. 1). For example, the payment management module 18 may be configured to operate as if the calculated stand-in liquidity is the actual liquidity and compares that amount to the requested payment to determine whether there is sufficient liquidity to complete the requested payment.

At some point in time following the downtime of the liquidity management repository 24 and following completion of the payment during that downtime, the server 14 receives further status signals 26, either in response to a query from the server 14 or without such prompting, generated by the payment processing system 16. The signals 26 indicate that the liquidity management repository 24 is no longer down. Such status signals can be processed by the data updating module 21.

In response to the status signals 26, the data updating module 21 is configured to cause the server 14 to generate transaction data signals 29 which are transmitted, via the network 234 and received by the payment processing system 16. The transaction data signals 29 are based on the payment completed during the downtime and cause the payment processing system to update the liquidity data stored in the liquidity management repository 24 to reflect any payments completed to or from the corresponding transaction account(s) during the downtime.

In some examples, in conjunction with generating the transaction data signals 29 to update the liquidity data stored in the liquidity management repository 24, the data updating module 21 is also configured, on its own, or in cooperation with the stand-in activation module 20, to cause the server 14 to generate stand-in deactivation signals 41 to cause the payment processing system 16 to deactivate the stand-in liquidity management repository 25.

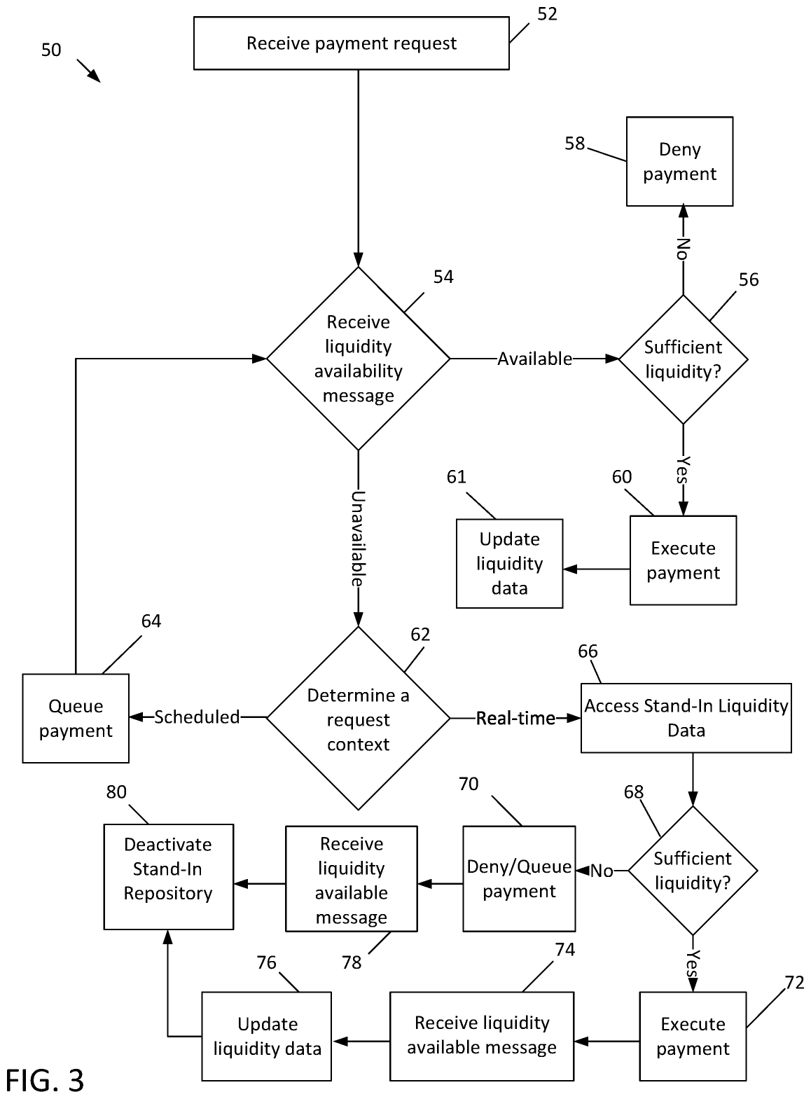

FIG. 3 shows an example method 50 that can be performed by the payment managing system of FIG. 1. The steps of the method 50 can be performed, e.g., by the various modules of the server 14 as described in connection with FIG. 2. Additional methods may include some but not all of the steps of the method 50. Additional methods may include some or all of the steps of the method 50 performed in a different order than that illustrated.

Referring to FIGS. 1-3, at a step 52 of the method 50, a payment request is received.

At a step 54 of the method 50, a liquidity availability message is received. For example, the liquidity availability message can correspond to the status signals 26.

If at the step 54 it is determined, based on the liquidity availability message, that the liquidity management repository 24 is available, the method 50 proceeds to the step 56.

At the step 56, it is determined, based on the available liquidity data in the liquidity management repository 24, if there is sufficient liquidity to complete the requested payment.

If it is determined at the step 56 that there is not sufficient liquidity, the method 50 proceeds to the step 58 and the payment request is denied, e.g., causing a message to be sent to the payor device 30 that displays on the I/O device 32 a message that the requested payment has been denied due to insufficient funds.

If it is determined at the step 56 that there is sufficient liquidity, the method 50 process to the step 60 and the payment is executed (also referred to herein as “completed”).

Once the payment is executed, at a step 61 of the method 50, the liquidity data stored in the liquidity management repository 24 is updated, e.g., using the data updating module 21 or the payment management module 18, to reflect the completed payment from the transaction account.

If at the step 54 it is determined, based on the liquidity availability message, that the liquidity management repository 24 is not available, the method 50 proceeds to the step 62. At the step 62, a context of the payment request is determined.

If the context is determined at the step 62 to be for a future scheduled payment, the method 50 proceeds to the step 64. At the step 64 the payment request is queued until a time after the liquidity management repository 24 is no longer down as indicated by another message received at the step 54, at which point the payment request can be considered at the step 56, based on its place in the queue, and the method 50 proceeds from the step 56 as described above.

If the context is determined at the step 62 to be for a real-time payment and, in some examples, the context otherwise indicates that a real-time payment is permitted, the method 50 proceeds to the step 66. At the step 66, stand-in liquidity data for the payor transaction account in question is accessed. This can occur, for example, after the stand-in liquidity management repository 25 is activated.

From the step 66, the method 50 proceeds to the step 68, where it is determined, based on the stand-in liquidity, whether there is sufficient liquidity in the transaction account in question to perform the requested payment.

If it is determined at the step 68 that there is not sufficient liquidity, the method 50 proceeds to the step 70 and the payment request in some examples is denied, e.g., causing a message to be sent to the payor device 30 that displays on the I/O device 32 a message that the requested payment has been denied due to insufficient funds.

In other examples, at the step 70 the payment request, despite lacking sufficient stand-in liquidity, is queued until after a message is received at the step 78 (e.g., corresponding to the status signals 26), that the liquidity management repository 24 is no longer down. At this later time, liquidity can be assessed again, based on actual liquidity stored in the liquidity management repository 24, to determine whether to complete the requested payment as described above.

Following or concurrently with the step 78, the method 50 proceeds to the step 80, at which the stand-in liquidity management repository 25 is deactivated in response to the liquidity management repository 24 no longer being down.

If it is determined at the step 68 that there is sufficient liquidity based on the stand-in liquidity data, the method 50 proceeds to the step 72 and the requested payment is executed.

From the step 72, the method 50 proceeds to the step 74 at which a message is received (e.g., corresponding to the status signals 26), that the liquidity management repository 24 is no longer down.

Once the message is received at the step 74, the method 50 proceeds to the step 76, at which the liquidity data in the liquidity management repository 24 is updated to reflect the payment that was completed while the liquidity management repository 24 was down.

Following or concurrently with the step 76, the method 50 proceeds to the step 80, at which the stand-in liquidity management repository 25 is deactivated in response to the liquidity management repository 24 no longer being down.

### Example Computing Environment

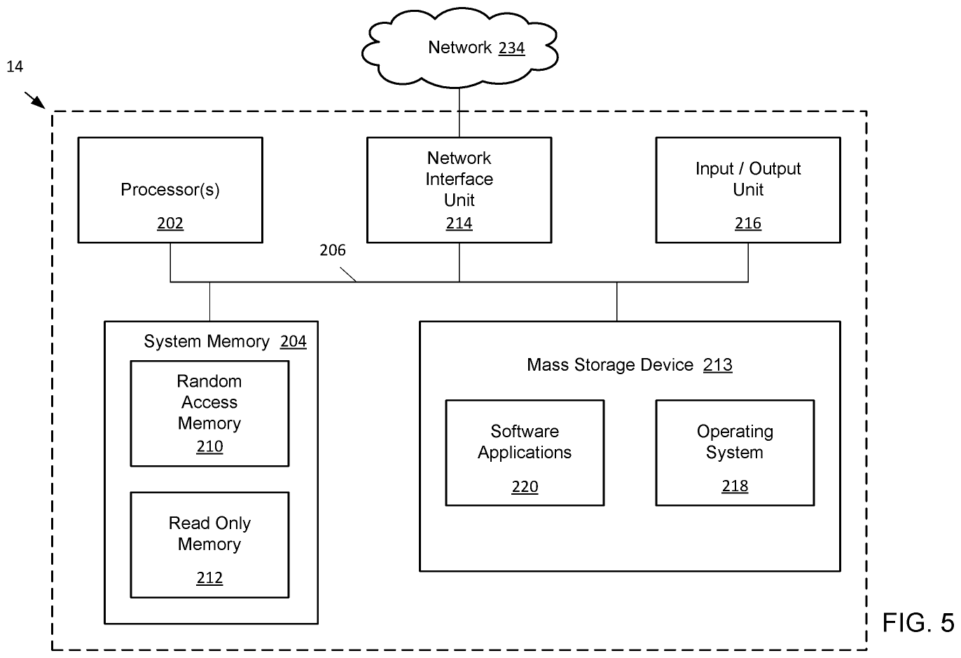

Additional components of the server 14 are illustrated in FIG. 5.

In this example of FIG. 5, the server 14 provides the computing resources to perform at least some of the functionality associated with the system 10 (FIG. 1).

The server 14 can be an internally controlled and managed device (or multiple devices) of an enterprise, e.g., a financial institution that offers various banking services to its customers. Alternatively, the server 14 can represent one or more devices operating in a shared computing system external to the enterprise, such as a cloud. Further, the other computing devices disclosed herein, such as the payor device 30, the payment processing system 16 to the extent it is standalone from the server 14, and any computing device that serves the payee account 38 (FIG. 1) can include the same or similar components.

Via the network 234, any components of the server 14 that are physically remote from one another can interact with one another, as well as with other computing resources, such as those shown in FIG. 1. The network 234 can be any suitable wired, wireless, cellular or other data network (or combination of networks) that enables data transmission between computing devices networked together.

The server 14 includes one or more processors 202. The one or more processors 202 are configured to carry out the functionality of the system 10 described above by executing computer-readable instructions stored on non-transitory computer-readable storage. The server 14 also includes a system memory 204 and a system bus 206 that couples the system memory 204 to the processor(s) 202.

The system memory 204 includes a random access memory (“RAM”) 210 and a read-only memory (“ROM”) 212. A basic input/output system that contains the basic routines that help to transfer information between elements within the server 14, such as during startup, is stored in the ROM 212.

The server 14 further includes a mass storage device 213. The mass storage device 213 is able to store software instructions and data such as those required for the payment management module 18, the liquidity tracking module 19, the stand-in activation module 20, the data updating module 21, the context module 22, and the account data 23 (FIG. 2), as well as to carry out any further functions of the server 14 and/or the payment processing system 16.

The mass storage device 213 is connected to the processor(s) 202 through a mass storage controller (not shown) connected to the system bus 206. The mass storage device 213 and its associated computer-readable data storage media provide non-volatile, non-transitory storage for the server 14. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 14.

According to various embodiments of the invention, the server 14 may operate in a networked environment using logical connections to remote network devices (such as the payor device 30, the payment processing system 16, and computing device supporting the payee account 38 shown in FIG. 1) through the network 234, such as a wireless network, the internet, or another type of network. The server 14 may connect to the network 234 through a network interface unit 214 connected to the system bus 206. It should be appreciated that the network interface unit 214 may also be utilized to connect to other types of networks and remote computing systems. The server 14 also includes an input/output unit 216 for receiving and processing input from a number of other devices, including a touch user interface display screen, an audio input device, or another type of input device.

As mentioned briefly above, the mass storage device 213 and/or the RAM 210 of the server 14 can store software instructions and data. The software instructions include an operating system 218 suitable for controlling the operation of the server 14. The mass storage device 213 and/or the RAM 210 also store software instructions and applications 220, that when executed by the processor(s) 202, cause the server 14 to provide functionality of the system 10 described above (FIG. 1).

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computing system for processing payment requests, comprising:
a processor; and
memory encoding instructions which, when executed by the processor, cause the computing system to:
receive, from a user device, a payment request for online payment from a transaction account;
receive, from a payment processing system, a message indicating that liquidity data associated with the transaction account and for processing the payment request is unavailable from a liquidity management repository;
in response to the message:
access a stand-in liquidity management repository; and
determine, based on stand-in liquidity data stored in the stand-in liquidity management repository, a previous liquidity balance for the transaction account at a time before the liquidity data became unavailable from the liquidity management repository; and
execute, by the payment processing system, a payment corresponding to the payment request based on the previous liquidity balance.

2. The computing system of claim 1, wherein to execute the payment request occurs while the liquidity data is unavailable from the liquidity management repository.

3. The computing system of claim 1, wherein to determine the previous liquidity balance occurs while the liquidity data is unavailable from the liquidity management repository.

4. The computing system of claim 1, wherein the stand-in liquidity management repository stores the stand-in liquidity data in a distributed ledger.

5. The computing system of claim 4, wherein the stand-in liquidity management repository includes a plurality of databases.

6. The computing system of claim 1, wherein the stand-in liquidity management repository stores the stand-in liquidity data in a transaction ledger.

7. The computing system of claim 1, wherein the memory encodes further instructions which, when executed by the processor, cause the computing system to:
update, based on the payment, the liquidity data stored in the liquidity management repository.

8. The computing system of claim 7, wherein to update the liquidity data occurs after the liquidity data becomes available.

9. The computing system of claim 1, wherein the liquidity data and the stand-in liquidity data are stored according to different database schema.

10. A computer-implemented method for processing payment requests, comprising:
receiving, from a user device, a payment request for online payment from a transaction account;
receiving, from a payment processing system, a message indicating that liquidity data associated with the transaction account and for processing the payment request is unavailable from a liquidity management repository;
in response to the message:
determining a context of the payment request;
when the context is determined to be a first context, accessing a stand-in liquidity management repository to enable the payment processing system to execute a payment corresponding to the payment request while the liquidity data is unavailable from the liquidity management repository; and
when the context is determined to be a second context different from the first context, queueing execution of the payment corresponding to the payment request until after the liquidity data becomes available from the liquidity management repository.

11. The computer-implemented method of claim 10,
wherein the first context indicates that the payment request is for a real-time payment from the transaction account; and
wherein the second context indicates that the payment request is for a future scheduled payment from the transaction account.

12. The computer-implemented method of claim 10, further comprising:
when the context is the first context, executing, by the payment processing system, the payment corresponding to the payment request while the liquidity data is unavailable from the liquidity management repository.

13. The computer-implemented method of claim 10, further comprising:
when the context is the second context, executing, by the payment processing system, the payment corresponding to the payment request after the liquidity data becomes available from the liquidity management repository.

14. The computer-implemented method of claim 10, further comprising:
when the context is the first context, updating, based on the payment, the liquidity data stored in the liquidity management repository.

15. The computer-implemented method of claim 14, wherein the updating occurs after the liquidity data becomes available from the liquidity management repository.

16. The computer-implemented method of claim 10, wherein the liquidity data and stand-in liquidity data stored in the stand-in liquidity management repository are stored according to different database schema.

17. The computer-implemented method of claim 16, wherein the stand-in liquidity management repository stores the stand-in liquidity data in a distributed ledger.

18. The computer-implemented method of claim 16, wherein the stand-in liquidity management repository stores the stand-in liquidity data in a transaction ledger.

19. The computer-implemented method of claim 10, wherein the stand-in liquidity management repository includes a plurality of databases.

20. A computing system for processing payment requests, comprising:
a processor; and
memory encoding instructions which, when executed by the processor, cause the computing system to:
receive, from a user device, a payment request for online payment from a transaction account;
receive, from a payment processing system, a message indicating that liquidity data associated with the transaction account and for processing the payment request is unavailable from a liquidity management repository;
in response to the message:
determine whether the payment request is for a real-time payment from the transaction account or for a scheduled future payment from the transaction account;
when the payment is for a real-time payment from the transaction account:
access a stand-in liquidity management repository;
determine, based on stand-in liquidity data stored in the stand-in liquidity management repository, a previous liquidity balance for the transaction account at a time before the liquidity data became unavailable from the liquidity management repository; and
execute, by the payment processing system, a payment corresponding to the payment request based on the previous liquidity balance; and
when the payment is for a scheduled future payment from the transaction account:
queue execution of the payment corresponding to the payment request until after the liquidity data becomes available from the liquidity management repository; and
execute, by the payment processing system, the payment corresponding to the payment request after the liquidity data becomes available from the liquidity management repository.
